(19) United States
(12) Patent Application Publication
(10) Pub. No.: US 2011/0162391 A1
(43) Pub. Date: Jul. 7, 2011

(54) Method and Apparatus for Providing Temperature Control to a Cryopump

(76) Inventors: Doreen J. Ball-DiFazio, Hopkinton, MA (US); William L. Johnson, Andover, MA (US); Ronald N. Morris, Bedford, MA (US); Robert P. Sullivan, Wilmington, MA (US)

(21) Appl. No.: 12/981,806

(22) Filed: Dec. 30, 2010

Related U.S. Application Data
(63) Continuation of application No. PCT/US2009/049245, filed on Jun. 30, 2009.
(60) Provisional application No. 61/133,623, filed on Jul. 1, 2008.

(51) Int. Cl. B01D 8/00

(52) U.S. Cl. 62/55.5

(57) ABSTRACT

Cryopump components are improved using thin layer heating elements for temperature control or to serve as heaters. These heating elements may be located and prevent pooling during regeneration. The temperature control may also be achieved through the use of ceramic heating elements. The ceramic heating elements may also include a second function of structural support within the cryopump. Temperature control may further be achieved via the radiation shield, where the radiation shield includes a clad sheeting or coating.

### RELATED APPLICATIONS

This application is a continuation of International Application No. PCT/US2009/049245, which designated the United States and was filed on Jun. 30, 2009, published in English, which claims the benefit of U.S. Provisional Application No. 61/133,623, filed on Jul. 1, 2008.

The entire teachings of the above applications are incorporated herein by reference.

### BACKGROUND OF THE INVENTION

Vacuum process chambers are often employed in manufacturing to provide a vacuum environment for tasks such as semiconductor wafer fabrication, electron microscopy, gas chromatography, and others. Such chambers are typically achieved by attaching a vacuum pump to the vacuum process chamber by a vacuum connection such as a flange and a conduit. The vacuum pump operates to remove substantially all of the molecules from the process chamber, therefore creating a vacuum environment.

A cryogenic vacuum pump, known as a cryopump, employs a refrigeration mechanism to achieve low temperatures that will cause many gases to condense onto a surface cooled by the refrigeration mechanism. One type of cryopump is disclosed in U.S. Pat. No. 5,862,671, issued Jan. 26, 1999, and assigned to the assignee of the present application. Such a cryopump uses a two-stage helium refrigerator to cool a cold finger to near 10 Kelvin (K).

Cryopumps generally include a low temperature second stage array, usually operating in the range of 4 to 25 K., as the primary pumping surface. This surface is surrounded by a higher temperature radiation shield, usually operated in the temperature range of 60 to 130 K., which provides radiation shielding to the lower temperature array. The radiation shield generally comprises a housing which is closed except through a frontal array positioned between the primary pumping surface and a work chamber to be evacuated.

In operation, high boiling point gases such as water vapor are condensed on the frontal array. Lower boiling point gases pass through that array and into the volume within the radiation shield and condense on the lower temperature array. A surface coated with an adsorbent such as charcoal or a molecular sieve operating at or below the temperature of the colder array may also be provided in this volume to remove the very low boiling point gases such as hydrogen. With gases thus condensed and/or adsorbed onto the pumping surfaces, only a vacuum remains in the work chamber.

A radiation shield may be employed around the cryogenic array to minimize the thermal load on the cryogenic array. Such a radiation shield may take the form of an enclosure around the cryogenic array, and may include louvers or chevrons to allow fluid communication with the vacuum process chamber.

Since the cryogenic arrays and radiation shield are cooled to very low temperatures, heat flow to the cryogenically cooled surface is ideally minimized. Undesired heat increases the time required to cool down the pump, increases the helium consumption of the pump, and influences the minimum temperature the cryopump achieves.

After several days or weeks of use, the gases which have condensed onto the cryopanels, and in particular the gases which are adsorbed, begin to saturate the cryopump. A regeneration procedure must then be followed to warm the cryopump and thus release the gases and remove the gases from the system. As the gases evaporate, the pressure in the cryopump increases, and the gases are exhausted through a relief valve or other exhaust valve or conduit. During regeneration, the cryopump is often purged with warm nitrogen gas. The nitrogen gas hastens warming of the cryopanels and also serves to flush water and other vapors from the cryopump. Nitrogen is the usual purge gas because it is inert and is available free of water vapor. It is usually delivered from a nitrogen storage bottle through a conduit and a purge valve coupled to the cryopump or as boil off from a liquid nitrogen source.

After the cryopump is purged, it must be rough pumped to produce a vacuum about the cryopumping surfaces and cold finger to reduce heat transfer by gas conduction and thus enable the cryocooler to cool to normal operating temperatures. The rough pump is generally a mechanical pump coupled through a conduit to a roughing valve mounted to the cryopump.

Control of the regeneration process is facilitated by temperature gauges coupled to the cold finger heat stations. Ionization pressure gauges have also been used with cryopumps but have generally not been recommended because of a potential of igniting gases released in the cryopump by a spark from the current-carrying thermocouple. The temperature and/or pressure sensors mounted to the pump are coupled through electrical leads to temperatures and/or pressure indicators.

Although regeneration may be controlled by manually turning the cryocooler off and on and manually controlling the purge and roughing values, a separate or integral regeneration controller is used in more sophisticated systems. Leads from the controller are coupled to each of the sensors, the cryocooler motor and the valves to be actuated.

A controller regulates heaters to provide temperature control of the refrigeration mechanism, heat stations, and cryopumping surfaces of the cryopump during cold operation or regeneration.

Some cryopumps do not have a low temperature second stage array. These single stage pumps have one primary pumping surface operating at temperatures similar to those of the frontal array of a two-stage cryopump. The warmer operating temperatures do not require the use of a radiation shield to protect the refrigerating mechanism from radiant heat.

### SUMMARY

New methods of providing temperature control to cryopumps and improved cryopump components are provided. According to example embodiments, a cryopump radiation shield comprises a first sheet material of high thermal conductivity and a second sheet material of high reflectivity (low emissivity) joined by a cladding process. The clad first and second sheet materials may be configured in a cup shaped formation with substantially cylindrical walls with the high reflectivity material on the outer cylindrical surface. The first sheet material may be an inner surface of the cup shaped formation and may have a high emissivity surface. The first sheet material may, for example, be aluminum or copper. The second sheet material may, for example, be stainless steel.

A thin layer heating element, including a resistive layer in a clad radiation shield or cryoarray, a thin film heater, foil heater, spray-on resistive material, or resistive pattern may be placed on components of a cryopump (e.g., refrigerators, radiation shields, cryoarrays) to provide temperature control during cold operation or regeneration where the heating element also may be configured to boil off cryogenic pooling during regeneration. Direct placement of the thin layer heater at locations of pooling in either radiation shields or cryopanels aids in the evaporation of the pooled material. Pooled material leads to longer regeneration times, thus the addition of a thin heater at the location of the pooled material provides more efficient use of heating energy.

The first or second sheet material of a clad radiation shield may have a high resistance, the first or second sheet of high resistance may be electrically isolated by an insulating layer. The first or second sheet of high resistance may provide resistance heating when a current is applied. The radiation shield may further include a third sheet material having a high resistance. The clad sheeting may be formed by the bonding of the three sheet materials with the third sheet material being in between the first and second sheet materials. A current may be applied to the third sheet material to provide a resistive heating. The third sheet may be electrically isolated by two insulating layers.

A cryoarray member, such as a cryopanel surface for cryopumping or a bracket supporting the cryopanels, may also be made of two or more sheet materials. One of the two sheets may have high resistance to provide resistive heating to the cryopanel member. An electrically insulated layer may be placed between the two sheets of material. Alternatively, the cryopanel array member may include a multi-layer clad sheeting featuring an upper and lower sheet material, and a high resistance sheet material. The high resistance sheet material may be positioned in between the upper and lower sheet materials and isolated by two insulating sheet materials.

The radiation shield may also be coated with a resistive pattern. A current may be applied to the resistive pattern thereby providing a resistive heating. The resistive pattern may be electrically isolated by an insulating layer. The cryopanel array member may include an upper and lower surface, where a coating in the form of a resistive pattern may be applied to either the upper or lower surface to provide the resistive heating.

An additional embodiment includes placement of separate thin film heaters on the radiation shield in sections that reflect the potential orientations that the cryogenic pump may be mounted. An orientation sensor would then automatically sense the orientation and only those heaters would be energized where the liquids would pool during regeneration.

In another embodiment the thin layer heaters, including a thin film, foil or spray-on resistive material, may be attached directly to the cryoarray members (e.g., cryopanels, brackets), to provide direct heating where the gases are condensed or adsorbed. The thin layer heaters may be placed on the surface of the cryopanels, where gases are condensed or an adsorbent is attached. The thin layer heaters may also be attached to the underside of the array disks.

In another embodiment the thin layer heaters consist of multiple heaters to provide uniform or selective heating as needed for temperature control during cryogenic operation or regeneration. Selective control may either be made manually or through programming of a controller before or upon installation or when operating conditions change.

In other example embodiments a cryopump comprises a refrigerator having a first stage and a second stage. A heating element is configured to provide both temperature control and structural support within either stage. The heating element may be a ceramic heater in the form of a cryopump structural component. The heating element may be a radiation shield configured to provide resistive heating. The cryopump may have only one stage or be multistage.

For each of the embodiments, control of the heating solutions may be manual or automated through a separate, integral, or host controller. The controller regulates the amount of heat from the heater to enable control of the temperatures of the radiation shield, cryopanel members, or structural support of the cryopump.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a side view of a cryopump;

FIG. 2 is a clad sheeting radiation shield according to example embodiments;

FIG. 3A is a radiation shield employing a heating method of temperature control according to example embodiments;

FIG. 3B is a radiation shield featuring a highly thermally conductive middle layer according to example embodiments;

FIG. 3C is a cryopanel section employing the heating method of temperature control of FIG. 3A according to example embodiments;

FIG. 3D is a cryopanel section featuring the highly thermal conductive middle layer of FIG. 3B according to example embodiments;

FIG. 4 is a cryopump component featuring ceramic structural heaters according to example embodiments;

FIG. 5 is a cryopump second stage featuring thin layer heating elements according to example embodiments;

FIGS. 6A and 6B are radiation shields including thin layer heating elements for pooling prevention according to example embodiments; and

FIG. 7 is a water pump including thin layer heating elements according to example embodiments.

### DETAILED DESCRIPTION

A description of example embodiments of the invention follows.

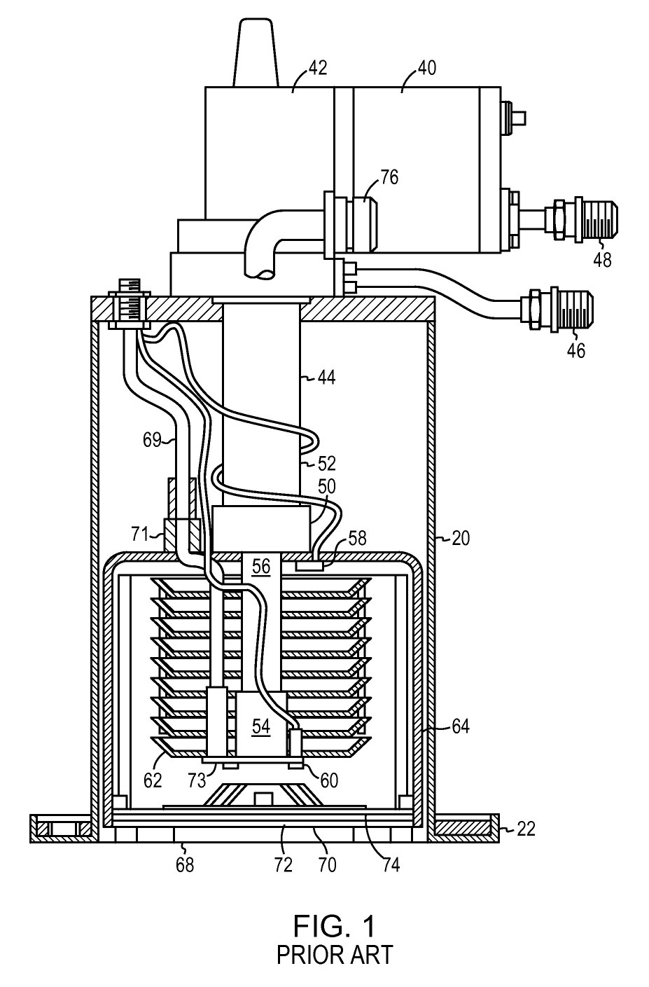

FIG. 1 shows a typical prior art cryopump. The cryopump 20 includes a drive motor 40 and a crosshead assembly 42. The crosshead converts the rotary motion of the motor 40 to reciprocating motion to drive a displacer within the two-stage cold finger 44 and provides opening and closing of inlet and exhaust valves. With each cycle, helium gas introduced into the cold finger under pressure through line 46 is expanded and thus cooled to maintain the cold finger at cryogenic temperatures. Helium then warmed by a heat exchange matrix in the displacer is exhausted through line 48.

A first-stage heat station 50 is mounted at the cold end of the first stage 52 of the refrigerator. Similarly, heat station 54 is mounted to the cold end of the second stage 56. Suitable temperature sensor elements 58 and 60 are mounted to the rear of the heat stations 50 and 54. The primary pumping surface is a cryopanel array 62 mounted to the heat sink 54. This array comprises a plurality of disks as disclosed in U.S. Pat. No. 4,555,907. Low temperature adsorbent is mounted to surfaces of the array 62 to adsorb noncondensible gases.

A cup-shaped radiation shield 64 is mounted to the first stage heat station 50. The second stage of the cold finger extends through an opening in that radiation shield 64. This radiation shield 64 surrounds the primary cryopanel array to the rear and sides to minimize heating of the primary cryopanel array by radiation. The temperature of the radiation shield may range from as low as 40 K to as high as 130 K. A frontal cryopanel array 70 serves as both a radiation shield for the primary cryopanel array and as a cryopumping surface for higher boiling temperature gases such as water vapor. This panel comprises a circular array of concentric louvers and chevrons 72 joined by a spoke-like plate 74. The configuration of this cryopanel 70 need not be confined to circular, concentric components; but it should be so arranged as to act as a radiant heat shield and a higher temperature cryopumping panel while providing a path for lower boiling temperature gases to the primary cryopanel. The frontal cryopanel array 70, while effective at reducing radiation, may tend to impede the flow of gases past the chevrons and louvers.

Also illustrated in FIG. 1 is a heater assembly 69 comprising a tube which hermetically seals electric heating units. The heating units heat the first stage through a heater mount 71, which may be attached to the heat station 50 at its outer diameter, and a second stage through a heater mount 73 for temperature control during cold operation or regeneration. The cryopump is typically attached to a vacuum process chamber via a conduit including a flange 22.

In the design and operation of cryopumps and vacuum systems, particular care is taken in the control and maintenance of temperature during the operation of the cryopump. In one example embodiment, during regeneration cryopump components are heated to accelerate volatilization. Heaters may also be used to enable control of the temperatures of the refrigerator heat stations, radiation shield, and cryopanel members.

Typically, prior art radiation shields are formed using a copper sheeting for high thermal conductance, manufactured in a cup shaped formation. The high conductance quickly moves heat from the radiation shield to the heat sink of the first stage to minimize radiation heating of the second stage. The radiation shield may also be made of multiple pieces of material that are thermally joined or individually tied to the heat sink.

Radiation shields are typically fabricated to include a high emissivity interior surface to reduce radiance to the second stage and a high reflectivity exterior surface to reduce the flow of radiant heat from the vacuum vessel to the first stage of the cryopump. The high emissivity interior surface of a prior art radiation shield is usually obtained by painting the interior surface of the copper sheeting black. The low emissivity, high reflectance exterior surface is typically obtained by a nickel plating process performed on the exterior surface of the copper sheeting. The nickel plating process typically involves an expensive electroplating process. A buffing or polishing process may also be employed on the exterior surface of the nickel plating surface to further reduce the emissivity of the exterior surface.

Prior art copper based radiation shields operate at elevated temperatures (50 K-150 K) compared to second stage cryocondensing components which operate below 20 K. Because of the isolation of the two temperature stages, opportunity exists to depart from standard cryogenic friendly materials (e.g., Oxygen Free High Conductivity Copper [OFHC], or other coppers) on the warmer first stage of the cryopump where thermal performance is not as constrained as in the colder second stage of the cryopump.

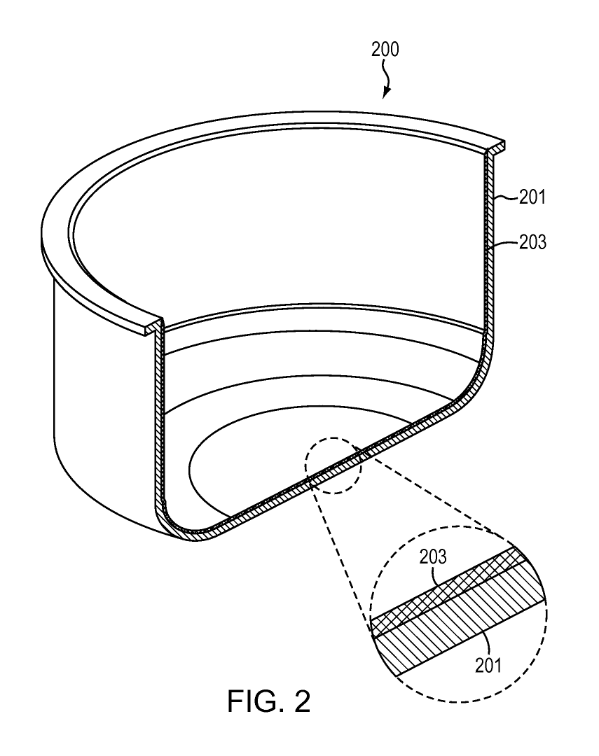

In an example embodiment of the present invention, a radiation shield 200 fabricated with a clad sheeting is employed, as illustrated in FIG. 2. Cladding defined clad layers may be provided with the use of mechanical or metallurgical bonding, or any other methods for bonding, or cladding, well known in the art; thereby eliminating the electroplating process and reducing the costs and complexity of manufacturing.

In FIG. 2, the clad sheeting of the radiation shield 200 may include an exterior surface 201 and an interior surface 203. The exterior surface 201 may be of low emissivity, high reflectivity, and low thermal conductance. The interior surface 203 may be of high emissivity, high thermal conductance, and low reflectivity. Such a configuration minimizes thermal radiation adsorption by the exterior surface 201, maximizes thermal radiation adsorption by the interior surface 203, and minimizes the release of radiant energy from the interior surface 203 to the second stage 56, arrays 62, and heat sink 54. The configuration of the radiation shield also conducts heat through the high thermal conductivity interior surface 203 to the lower temperature heat sink 50, of FIG. 1.

In example embodiments, the interior surface 203 may be aluminum and the exterior surface 201 may be stainless steel. Stainless steel typically requires no further processing unlike the copper which requires the nickel coating, or plating, of prior art radiation shield systems. The stainless steel also is more resistant than nickel or copper to the corrosive gases and liquids that the shield may be exposed to during operation in a cryopump.

The use of aluminum as an inner surface also has benefits over the prior art methods involving copper. Both the aluminum and the copper undergo a painting process to increase the emissivity of the inner surface of the radiation shield; however, typically the paint adheres well to the aluminum, more so than the prior art copper shields. Additionally, the surface finish of the nickel plating of prior art radiation shield requires complicated processing to obtain good adhesion of the paint. A spray-on carbon or other surface treatment such as anodize may also be employed to increase the emissivity of the interior surface instead of or in addition to the paint. Coatings can be used to provide either the low or high emissivity surfaces.

It should be noted that while aluminum is not as thermally conductive as copper, aluminum is less expensive to manufacture. Therefore, with the use of aluminum, a thicker interior layer may be utilized, as compared to prior art radiation shield systems. The thicker layer of aluminum may provide increased thermal conductivity. This increased thermal conductivity may improve the efficiency of radiant heat being drawn from the radiation shield to the first stage heat sink 50 to prevent the heat from radiating the second stage.

It should be appreciated that copper may also be used as an interior layer 203 of the clad sheeting. With the use of stainless steel as an exterior surface, rather than the nickel plating, a greater amount of structural support is provided. Thus, a thinner layer of copper may be utilized. The reduced layer of copper may be beneficial as it reduces the overall cost of manufacturing of the radiation shield. It should be appreciated that the highly conductive surface need not be the interior surface.

It should further be appreciated that either the interior surface 203 or the exterior layer 201 may be of high resistance. The thin layer of high resistance may be electrically isolated by having an insulating layer between the layers. The interior 203 or exterior 201 layer of high resistance may be configured to provide resistive heating when a current is applied to the layer.

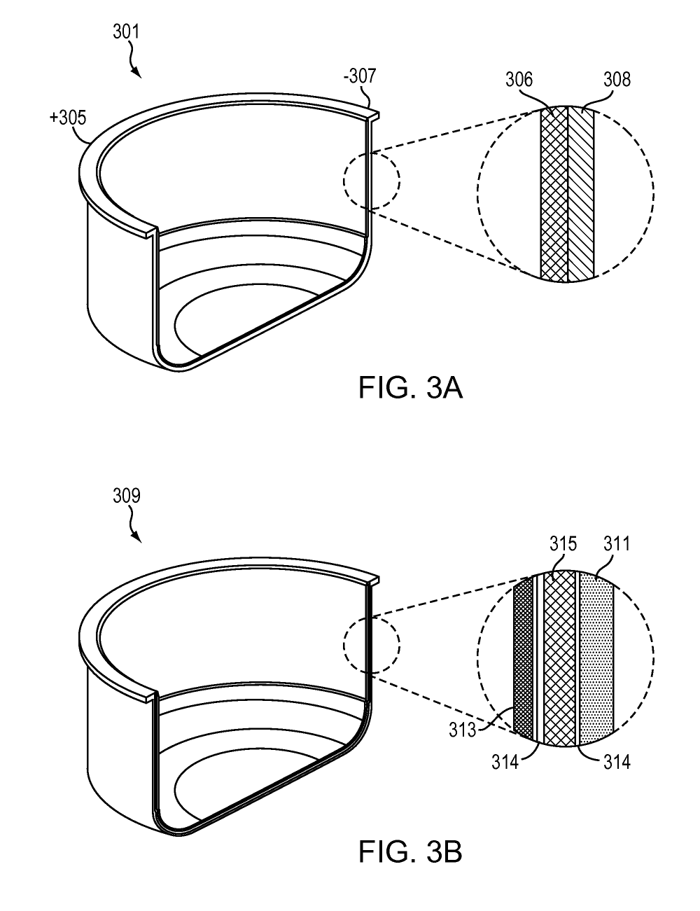

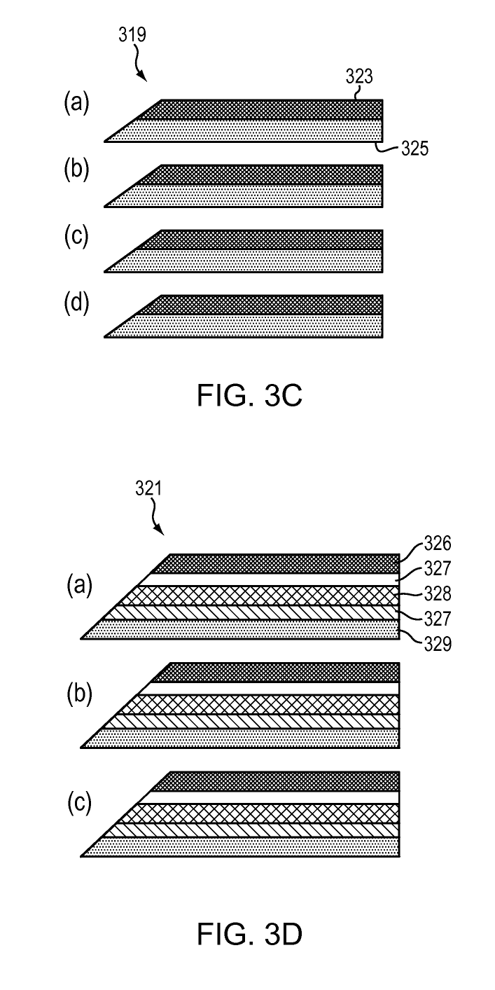

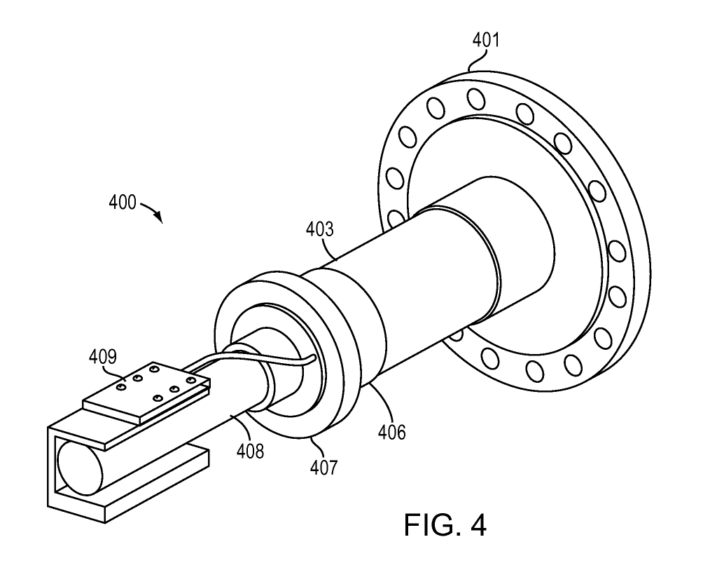

In other example embodiments, the radiation shield may function as a thin layer resistive heater to provide temperature control. FIG. 3A illustrates a radiation shield 301 of the cryopump. Electrical contacts 305 and 307 may be connected to an electrically resistive layer of the radiation shield 301. Through the electrical contacts 305 and 307, a current may be applied directly throughout the electrically resistive layer, which may be located on the inner 306 or outer 308 surface of the radiation shield 301, thereby creating resistive heat that may be utilized during the regeneration process or for temperature control.

In order to ensure that the current is run throughout the entire inner 306 or outer 308 surface of the radiation shield 301, a thin layer resistive pattern may be used, where the current may travel along the resistive pattern. The resistive pattern may run throughout the entire surface of the radiation shield 301 in order to ensure current is spread evenly to the entire surface of the radiation shield 301. It should be appreciated that the resistive pattern may be formed in a serpentine configuration. Alternatively, the resistive pattern may be formed in multiple localized places throughout the radiation shield. For example, the resistive heat may be used to prevent pooling during regeneration. The resistive pattern may be electrically isolated from the radiation shield surface.

In an additional embodiment, FIG. 3B illustrates a multi-layer radiation shield 309. The radiation shield 309 may include an exterior layer 311 and an interior layer 313 similar to the surfaces described in relation to FIG. 2. The radiation shield 309 may additionally include a highly resistive middle thin layer 315. Buffering layers 314 may be placed on both sides of the highly resistive middle layer 315 in order to electrically isolate the middle layer 315 from the interior 313 and exterior 311 layers. Drain holes may be provided as appropriate.

The electrical contacts may be applied to the middle surface 315 in a same manner as described in FIG. 3A. The middle layer may also employ a thin layer resistive pattern that may or may not be localized. It should also be appreciated that the current need not be directly applied to the interior 313, exterior 311, or middle 315 surface of the radiation shield but may also be applied to a thin layer heating elements fixed to or impregnated within the shield. It should further be appreciated that the radiation shield need not be a clad radiation shield in order to employ the radiation shield as a resistive body.

It should be appreciated that other components of the cryopump may include clad layers featuring a highly resistive thin layer and/or a thin layer resistive pattern, for example, the cryoarrays with cryopanels and structural brackets that may be used to connect the cryopanels to one another or to the refrigerator.

FIG. 3C illustrates a cryopanel array section 319 featuring four array members, or disks, (a)-(b). Each array member may include an upper 323 and lower 325 surface. A thin layer coating in form of a resistive pattern may be applied to either the upper 323 or lower 325 surface. Passing a current through the resistive pattern may provide a resistive heating that may be used to control the temperature of the cryopanel array. It should be appreciated that the upper 323 and lower 325 surfaces may be clad sheeting. It should further be appreciated that either the upper 323 or the lower 325 surfaces may be of high resistance and isolated via insulating layers. The thin layer of high resistance may also provide a resistive heating with the application of current.

FIG. 3D illustrates another cryopanel section 321 featuring three array members, or disks, (a)-(c). Each array member may comprise a multi-layer clad sheeting. The multi-layer clad sheeting may include an upper surface 326 and a lower surface 329. A high resistance layer 328 may be provided between the upper 326 and lower 329 surface, with insulating layers 327 electrically isolating the high resistance layer 328. A current may be applied to the high resistance thin layer in order to provide a resistive heating.

The improved radiation shields of FIGS. 2, 3A, and 3B provide illustrations of a cryopump member that may be employed as both a heating element and a structural support element. In other example embodiments, heat control may be achieved through the use of ceramic heaters, which also provide structural support. The ceramic heaters may be in either a standard plate configuration or designed as components of the cryopump. Ceramic cryopump components may be provided, for example, by molding or manufacturing ceramic parts as integrated cryopump components that may have dual usage as both a heat source and as a structural component, such as a heat sink and/or mounting component for cryopanels. The ceramic cryopump components may also be used, in addition to heating, as a gas condensing surface of the cryopanel array.

FIG. 4 provides an illustrative example of ceramic cryopump components, which may be utilized for temperature control and/or accelerated regeneration. FIG. 4 illustrates a two stage cold finger 400, similar to the cold finger 44 of FIG. 1, having a first stage 403 and second stage 408. A mounting plate 401 may be connected to the cryopump vessel. The first stage of the cold finger 403 contains a heat sink 406 to which the radiation shield is typically mounted.

In this embodiment, the heat sink 406 is mounted to a heating ring 407 that may provide further support to the radiation shield. The ring 407 may be formed of a ceramic material configured to be temperature controlled. Thus, in addition to providing structural support to a radiation shield, the ring may be used during the regeneration process to increase the rate of volatilization. Furthermore, due to the ring's proximity to the heat sensor 58, shown in FIG. 1, the ring 407 may also be employed in temperature regulation of the heat sink or radiation shield during the all operation cycles of the cryopump.

The second stage of the cold finger 408 may include a ceramic heater in the form of a standard plate 409. The heating plate 409 may be located near or on the heat station 54 shown in FIG. 1. Similar to the ring 407, the heating plate 409 may provide structural support by providing a mounting surface for the cryopanel array 62 and/or temperature sensor element 60 as shown in FIG. 1. It should be appreciated that the configuration shown in FIG. 1 features a top entry cold finger, while the configuration of FIG. 4 illustrates a side entry cold finger. The heating plate 409 may also be configured to provide temperature control during the operation cycles of the cryopump.

It should be appreciated that ceramic cryopump components may be in the form of any article typically used in a cryopump, for example ceramic components may also be in the form of the cryopanel array. It should also be appreciated that any number of ceramic components or standard plate configuration ceramic heaters may be utilized in a cryopump at once.

In other example embodiments, temperature control is provided by other thin layer heating elements applied to surfaces of cryoarray members, refrigerators and\or the radiation shield. The thin layer heating elements may be in the form of a foil, thin film, and\or spray-on heaters. The thin layer heating elements may also include a high resistive graphite. Thin layer heaters may be placed over a larger surface areas or consist of multiple smaller heating elements and may also include a high resistive layer and therefore may require lower power for operation. The thin layer heating elements may be used at localized surfaces where temperature control and/or accelerated regeneration is desired such as radiation shield and cryopumping surfaces. The thin layer heaters may require the use of electrically insulating materials to electrical isolate the heaters from the substrates.

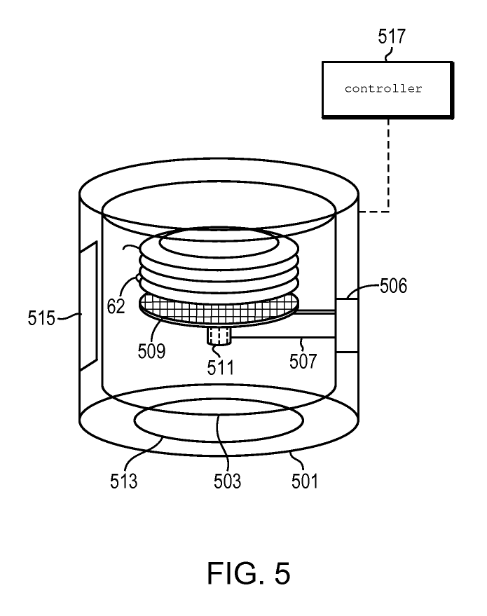

FIG. 5 illustrates a cryopump vessel or housing 501 enclosing a radiation shield 503. It should be appreciated that the radiation shield may be a clad or non-clad radiation shield. FIG. 5 also illustrates the cold finger entry sub-component 506, which may feature the ring 407 illustrated in FIG. 4. Extending from the entry sub-component is the second stage cold finger 507. At the end of the cold finger 507, a cryopanel 62 array may be found. A thin layer heating element 509 may be placed on any number of the cryoarray members 62, or on the heat station 54, for example thin layer heating element 511, as illustrated in FIG. 1, on the second stage heat station 54.

Thin layer heating elements may also be placed along the surface of the vessel or housing 501. A single or multiple thin layer heating elements may be placed anywhere along the surface of the housing 501, for example thin layer heating elements 513 and 515. Thin layer heating elements 513 and 515 may be used to provide further energy for boil off during cryopump regeneration. It should be appreciated that the heating provided by the thin layer heating elements, as well as the radiation shield and ceramic components, may be adjusted via a controller 517.

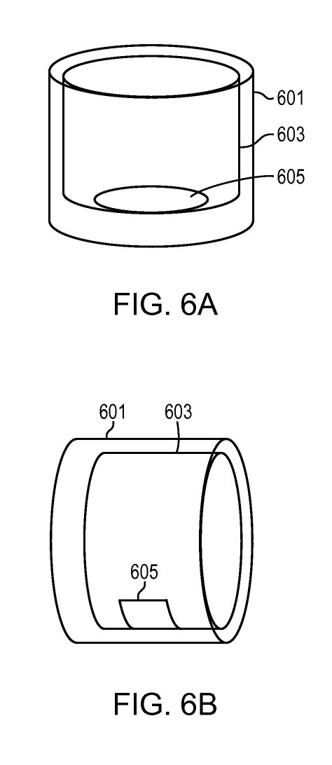

In other example embodiments, thin layer heating elements may also be placed on the surface of the radiation shield. Furthermore, the placement of the thin layer heating element may be determined for the purpose of boil off of pooling liquids during regeneration. FIG. 6A illustrates a cryopump vessel 601 enclosing a radiation shield 603. In the example provided by FIG. 6A, the pooling may be expected to form on the bottom surface on the interior wall of the radiation shield, due to the cryopump being configured for a vertical orientation. Thus, thin layer heating element 605 may be placed on a bottom surface of the interior wall of the radiation shield 603.

FIG. 6B illustrates an example of pooling prevention with the use of thin layer heaters when the cryopump is in a horizontal position. In FIG. 6B, the cryopump vessel 601 enclosing the radiation shield 603 is orientated horizontally, therefore the expected pooling area may be formed on a side wall of the inner surface of the radiation shield 603. Thus, the thin layer heating element 605 may be placed on the expected area of pooling.

It should also be appreciated that the temperature control methods described herein may be applied to include compressors, turbomolecular pumps, roughing pumps, water pumps, chillers, valves, gauges and other vacuum systems.

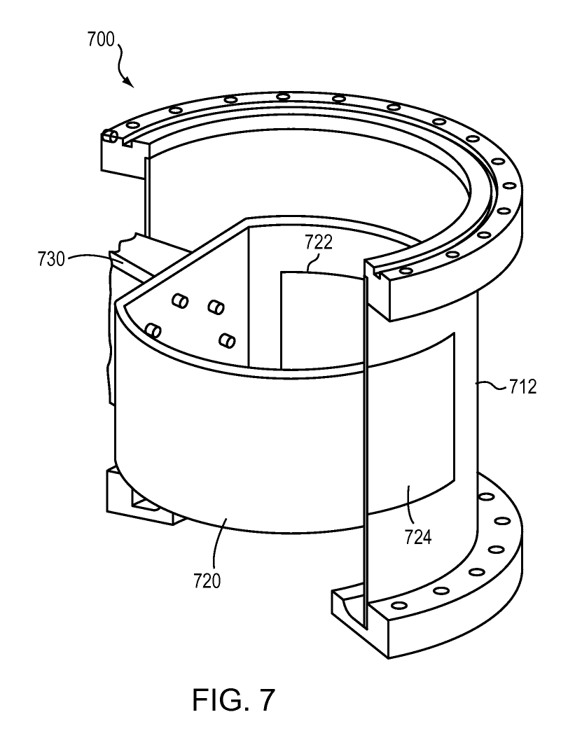

FIG. 7 illustrates a water pump 700 including an array 720 encased by a fluid conduit 712 and attached to a heater 730. Similarly to the radiation shield 603 of FIGS. 6A and 6B, thin layer heating elements (e.g., thin layer heating element 722) may also be placed along the surface of the array 720 for providing temperature control during operation and during regeneration. Thin layer heating elements (e.g., thin layer heating element 724) may be placed on the surface of the fluid conduit to provide temperature control during regeneration. Heating thin layers 722 and 724 may consist of more than one heating element allowing operation of heater elements where pooling may occur during regeneration.

It should be appreciated that any number of thin layer heating elements may be used in conjunction with the ceramic heaters and/or clad radiation shields. It should also be appreciated that the various heating elements may be controlled independently. For example, the radiation shield may include multiple thin layer heating elements placed on the surface of the radiation shield or cryopump vessel. Using gravitational sensors the orientation (e.g., vertical or horizontal) of the radiation shield may be determined. Once the orientation of the radiation shield is known, an appropriate thin layer heating element may be selected, manually or automatically, to volatize the expected pooling area. The thin layers may also be used on areas of cryoarrays where pooling during regeneration may occur. Identification of orientation of the pump may also be established during initial programming at installation of the cryopump. The establishment of orientation may be automatic or inputted manually, It should also be appreciated that the thin layer heating elements may include a protective coating, for example Kapton®, in order to protect the thin layer heating elements from any pooled material.

It should further be appreciated that heating elements may comprise independent roles (e.g., a heating element may be configured to be used solely for regeneration, or solely for temperature control during cryogenic operation). It should also be appreciated that any of the above temperature control embodiments above may be employed in conjunction with temperature sensors in order to prevent or reduce hot spots during the operation of the cryopump.

It should also be appreciated that the application of thin layer heaters materials may be extended to single stage cryogenic vapor pumps and cryopumps with more than two stages.

It should further be appreciated that any of the temperature control/accelerated regeneration embodiments described above may be used in any number and/or combination. It should further be appreciated that any of the above described embodiments may be used for dual purposes (e.g., for pooling prevention, temperature control, structural support, and/or regeneration).

While this invention has been particularly shown and described with references to example embodiments thereof, it will be understood by those skilled in the art that various changes in form and details may be made therein without departing from the scope of the invention encompassed by the appended claims.

1. A cryogenic unit comprising:
a refrigerator,
components cooled by the refrigerator including at least one cryogenic pumping surface; and
at least one electrical thin layer heating element in connection with a cooled component.

2. The cryogenic unit of claim 1 where the at least one thin layer heating element provides temperature control of the pumping surface.

3. The cryogenic unit of claim 1 wherein the at least one thin layer heating element is attached to a component having the pumping surface.

4. The cryogenic unit of claim 1 wherein the electrical thin layer heating element comprises a thin film heater, foil heater, spray-on heater, or resistive pattern.

5. The cryogenic unit of claim 1 wherein the at least one thin layer heating element is electrically insulated from the pumping surface.

6. The cryogenic unit of claim 1 wherein the at least one thin layer heating element is located in a gravitational low region of the pumping surface.

7. The cryogenic unit of claim 6 wherein a gravitational sensor is used to determine the thin layer heating elements that are located at the gravitational low region of the pumping surface.

8. The cryogenic unit of claim 1 further including a controller configured to control the temperature of the cryogenic unit by regulating the at least one thin layer heating element.

9. The cryogenic unit of claim 8 wherein the controller is configured to receive orientation of the unit as an input.

10. The cryogenic unit of claim 1 further including a controller configured to control the temperature of the cryogenic pumping surfaces by regulating the at least one thin layer heating element.

11. The cryogenic unit of claim 1 wherein the thin layer heater is located on a heat station of the refrigerator.

12. The cryogenic unit of claim 1 further including a radiation shield, the at least one thin layer heating element providing temperature control of the radiation shield.

13. The cryogenic unit of claim 12 wherein the at least one thin layer heating elements is located in a gravitational low region of the radiation shield.

14. The cryogenic unit of claim 13 wherein a gravitational sensor is used to determine the thin layer heating elements that are located at the gravitational low region of the radiation shield.

15. The cryogenic unit of claim 12 further including a controller configured to control the temperature of the radiation shield by regulating the at least one thin layer heating element on the radiation shield.

16. The cryogenic unit of claim 15 wherein the controller is configured to receive orientation of the unit as an input.

17. The cryogenic unit of claim 15 wherein the at least one thin layer heating element is configured to selectively energize heating elements in distinct regions of the radiation shield.

18. The cryogenic unit of claim 1 wherein the at least one thin layer heating element is configured to selectively energize heating elements in distinct regions of the cryogenic unit.

19. The cryogenic unit of claim 1 wherein the unit comprises plural temperature stages.

20. A cryopump cryoarray member comprising at least one electrical thin layer heating element.

21. The cryoarray member of claim 20 wherein the electrical thin layer heating element comprises a thin film heater, foil heater, spray-on heater, resistive pattern, or a resistive layer in a clad structure that forms a pumping surface.

22. The cryoarray member of claim 20 wherein the member consists of at least two sheet materials bonded together as a clad sheeting material.

23. A cryopump radiation shield comprising at least one electrical thin layer heating element.

24. The radiation shield member of claim 23 wherein the electrical thin layer heating element comprises a thin film heater, foil heater, spray-on heater, resistive pattern, or a resistive layer in a clad structure that forms the radiation shield.

25. The radiation shield of claim 23 wherein the shield comprises of at least two sheet materials bonded together as a clad sheeting material.

26. The radiation shield of claim 25 further comprising a third thin layer sheet material having a high resistance, the third sheet material being bonded between the first and second sheet material in the clad sheeting, the third sheet material also being configured to provide a resistive heating.

27. The radiation shield of claim 26 wherein the third sheet is electrically insulated from the other two sheets.

28. A cryogenic unit comprising:
a refrigerator, and
at least one electrical thin layer heating element configured to provide temperature control for the refrigerator.

29. The cryogenic refrigerator of claim 28 wherein the electrical thin layer heating element comprises a thin film heater, foil heater, spray-on heater, resistive pattern, or a resistive layer in a clad structure.

30. A cryopump comprising:
a refrigerator,
at least one cryopanel, and
a radiation shield with at least one thin layer heating element on the shield to provide temperature control of the radiation shield wherein the thin layer heating element comprises a thin film heater, foil heater, spray-on heater, resistive pattern, or a resistive layer in a clad structure.

31. A cryopump comprising:
a refrigerator, and
a cryoarray with at least one thin layer heating element on the array to provide temperature control of the array, the thin layer heating element comprising a thin film heater, foil heater, spray-on heater, resistive pattern, or a resistive layer in a clad structure.

32. A cryopump radiation shield comprising:
a first sheet material, and
a second sheet material; the first and second sheet materials bonded together as a clad sheeting wherein the first sheet faces the cryogenically cooled surfaces and the second sheet faces away from the cryogenically cooled surfaces.

33-41. (canceled)

42. A cryogenic unit comprising:
a refrigerator including at least one stage; and
a heating element configured to provide temperature control and structural support to a cryopumping surface.

43-45. (canceled)

46. The cryogenic unit of claim 1 wherein the electrical thin layered heating element comprises a resistive layer in a clad structure that forms a pumping surface.
